(19) United States
(12) Patent Application Publication
(10) Pub. No.: US 2012/0241628 A1
(43) Pub. Date: Sep. 27, 2012

(54) DETECTOR FOR THE DETECTION OF IONIZING RADIATION

(76) Inventors: Juergen Hesser, Heidelberg (DE); Frederik Wenz, Heidelberg (DE); Norbert Gretz, Mannheim (DE)

(21) Appl. No.: 13/320,330

(22) PCT Filed: May 11, 2010
(86) PCT No.: PCT/EP2010/002912

§ 371 Date: May 29, 2012

(30) Foreign Application Priority Data
May 12, 2009 (EP) 09159988.6

(51) Int. Cl. G01T 1/20

(52) U.S. Cl. 250/362; 250/361 R; 250/363.01

(57) ABSTRACT

The invention relates to a detector (110) for the detection of ionizing radiation (116). The detector (110) comprises at least one scintillator (112) which is adapted to convert the ionizing radiation (116) to electromagnetic radiation (118), especially to visible, ultraviolet or infrared light. The detector (110) further comprises at least one organic photovoltaic element (114) which is adapted to convert the electromagnetic radiation (118) to at least one electrical signal (120).

### FIELD OF THE INVENTION

The invention relates to a detector for detecting ionizing radiation as well as coatings, irradiation systems and cleaning devices which include a detector of this type. The invention furthermore relates to a method for detecting ionizing beams as well as a method for monitoring an irradiation system, using a detector according to the invention in each case. Devices and methods of this type are generally used, for example, in the field of radiation hygiene, for example in medical therapeutics, medical diagnostics, nuclear technology and research.

### BACKGROUND INFORMATION

In many areas of medicine, in natural sciences and technology, substances or devices are used which generate ionizing radiation. Substances of this type are also referred to in general as “radioactive substances.” Depending on the type of ionizing radiation, which may be, for example, particle radiation and/or electromagnetic radiation, a distinction is made between α, β and γ emitters. In the broadest sense, however, neutron sources may also be subsumed under “radioactive substances,” since, while neutrons themselves do not usually have any ionizing effect, they do have an activating effect and may thus also result in an ionization of irradiated materials. Within the scope of the present invention, ionizing radiation is thus generally understood to be radiation that is able to have a directly or indirectly ionizing effect on materials, for example on bodily tissue, and which includes one or more of the beams selected from α, β, γ, neutron radiation and x-rays.

Ionizing radiation of the type described is used, for example, in radiotherapeutics or radiodiagnostics in medicine. These branches of medicine are gaining increasing importance, in particular within the framework of oncology, but also in other areas of medicine. Furthermore, ionizing radiation is used in the field of materials science and technology, for example in the form of x-rays and γ radiation for testing materials, for example in bridge construction and automotive engineering. Other areas of application for ionizing radiation lie in nuclear engineering, for example in the area of power plants, or in biology, for example in the use thereof as marker materials.

When working with ionizing radiation or substances or devices that generate ionizing radiation, extreme caution must be exercised, in principle, since neither ionizing radiation itself nor the substances generating this ionizing radiation are usually perceptible to the human senses. The radiation exposure of the people or living organisms involved must therefore be monitored. On the other hand, however, the operability of the radiation sources must be checked at least at regular intervals. Steps must also be taken to ensure that objects or living organisms are not unintentionally and, in particular, unwittingly, contaminated by substances that generate ionizing radiation. This area of responsibility is also referred to, in particular, as “radiation hygiene.”

Numerous, complex detector systems which may be used for one or more of the aforementioned purposes are known from the prior art. In many cases, for example, dosimeters, which are able to operate according to different principles and, as a rule, are comparatively expensive to manufacture, operate and evaluate, are used in radioprotection applications to monitor a radiation dose. In particular, detectors such as Geiger counters, are used to monitor radiation contamination. Films are also employed which may be used to monitor a dose and/or a spatial distribution of ionizing radiation. However, known detectors are generally expensive, technologically complex and, in many cases, may be used only if contamination by substances that generate ionizing radiation is specifically suspected.

### OBJECT OF THE INVENTION

The object of the present invention is therefore to provide a detector which avoids the disadvantages of known detectors. In particular, the detector must be easy and economic to manufacture, flexible and versatile to use and, in particular, it must be able to be used in the area of radiation hygiene.

### SUMMARY OF THE INVENTION

This object is achieved by the devices and methods according to the independent claims. Advantageous refinements of the invention, which may be used alone or in combination, are illustrated in the dependent claims.

A fundamental idea of the present invention is to use scintillators in combination with organic photovoltaic elements to detect ionizing radiation. In contrast to conventional light detectors, which are used in combination with common scintillators, organic photovoltaic elements may be produced in nearly any form, designed flexibly and manufactured to cover a wide area, and they are well suited overall for achieving the aforementioned object.

A detector for detecting ionizing radiation in the sense of the above definition is therefore proposed, which includes at least one scintillator and at least one organic photovoltaic element. The scintillator is configured to convert ionizing radiation to electromagnetic radiation, in particular, to visible and/or ultraviolet and/or infrared light. This electromagnetic radiation is to be designed and/or output by the scintillator in such a way that it is able to be at least partially absorbed or detected by the organic photovoltaic element. The organic photovoltaic element is configured to convert the electromagnetic radiation to at least one electrical signal. This electrical signal may be output by the detector, for example via an interface, or as an alternative or in addition, it may also be used as an internal signal and forwarded, for example, to other elements of the detector, for example to the optional display element which is explained in greater detail below.

The detector may be configured, in particular, to generate at least one output signal corresponding to the electrical signal, either directly or indirectly, for example via a display element. This output signal may include, for example, an electrical output signal which may be output to a user and/or to another device, for example via an interface. As an alternative or in addition, the output signal may also include at least one optical and/or acoustic and/or haptic signal and/or a signal that is otherwise perceptible to a user, as explained in greater detail below, for example a signal output by a display element.

Within the scope of the present invention, a scintillator is generally understood to be a material and/or an element which is excited upon the passage and/or impingement of the ionizing radiation, which may be, for example, particle radiation and/or ionizing electromagnetic radiation, and emits this energy in the form of electromagnetic radiation, for example in the ultraviolet and/or visible and/or infrared spectral range. For example, this may be connected to the operation of a conversion, if the ionizing radiation also includes electromagnetic radiation. In this case, for example, the electromagnetic radiation may be converted to longer-wave electromagnetic radiation. In the case of particle radiation as ionizing radiation, a conversion to electromagnetic radiation takes place.

The scintillator may, in principle, include inorganic and/or organic scintillator materials. It is particularly preferably if the scintillator includes at least one organic scintillator material or is made entirely of an organic scintillator material, since organic scintillator materials are, in principle, comparatively easy to produce, and since purely organic or nearly exclusively organic layer structures may be produced, for example, when using organic scintillator materials, as explained in greater detail below. In particular, a process compatibility with the manufacture of the organic photovoltaic element may exist when using at least one organic scintillator material, which generally simplifies production. As an alternative or in addition, however, inorganic scintillators may also be used, in principle. An organic scintillator material may include, for example, an organic dye and/or a polymer or similar materials which are configured to emit the electromagnetic radiation when suitably excited by the ionizing radiation. Doped organic materials may also be used, for example organic matrix materials which are doped with an organic and/or inorganic dopant. Mixtures of organic and inorganic scintillator materials are also possible.

Examples of organic scintillator materials are anthracene, stilbene, terpenyl, diphenylazethylene, polyvinly toluene, toluene or xylene.

Inorganic scintillators can include, for example, crystals that may be doped with activator centers and/or color centers. Ionizing radiation may generate free electrons, free holes or electron-hole pairs, in particular excitons, in these solids. Excitation states of this type may move within the scintillator material until the excitation states decay, usually at activator centers, and emit the electromagnetic radiation. Examples of such inorganic scintillator materials are zinc sulfide, sodium iodide, bismuth germanate, lutetium oxyorthosilicate or combinations of the aforementioned and/or other scintillator materials.

Organic scintillators may include, in principle, crystals and/or liquids and/or polymeric solids. The scintillation mechanism in organic scintillators may be based, for example on an excitation of molecular states, for example in the form of fluorescent materials, the excited states being able to imitate, for example, ultraviolet radiation during decay. In addition, as in the inorganic scintillator materials, other conversion materials may also be included, for example, so-called “wavelength shifters,” which are able to convert, for example, shorter-wave electromagnetic radiation to longer-wave electromagnetic radiation.

In principle, the scintillator material may preferably be in solid form, preferably in flexible form, for example as one or multiple scintillator films. In principle, however, other aggregation states may be used as an alternative or in addition, for example liquid scintillators.

Within the scope of the present invention, an organic photovoltaic element is understood to be an element that is configured to convert electromagnetic radiation to electrical signals and which includes at least one organic material. The organic material may be, in particular, at least one organic layer, multilayer structures being preferred. For example, multiple organic function layers may be included, for example one or multiple conversion layers for converting the electromagnetic radiation to excited states in the organic material and/or one or multiple charge transfer layers for transferring positive or negative charges. The organic photovoltaic element may furthermore include one, preferably two or more, electrodes, for example at least one cathode and at least one anode, of which at least one is preferably designed to be at least partially transparent to electromagnetic radiation, in particular in the wavelength range emitted by the scintillator. Instead of a purely organic structure of the organic photovoltaic element, for example with the exception of one or more of the electrodes (whose materials may, in principle, be made of inorganic materials), hybrid elements may also be used, for example elements that combine inorganic and organic materials. For example, layer structures having one or multiple inorganic layers may be combined with one or multiple organic layers.

It is particularly preferably if the organic photovoltaic element includes at least one organic solar cell and/or at least one organic photodiode. In particular, at least one organic solar cell array and/or at least one organic photodiode array may be provided. A array is generally understood to be a one-, two- or three-dimensional arrangement of multiple active fields, for example multiple organic photodiode fields and/or multiple organic solar cell fields. Within the scope of the present invention, an organic solar cell may generally be understood to be a solar cell that has at least one organic chemical material. The organic material may be, for example, a low-molecular organic material and/or a polymeric material, combinations of the aforementioned materials also being possible and/or combinations with inorganic materials. In particular, organic materials having conjugated π electron systems may be used, in particular conjugated polymers. Acceptor materials may also be used, for example fullerenes. In particular, donator materials and acceptor materials may be combined with each other to form an organic solar cell structure. The organic solar cells may be produced, for example in wet chemical processes and/or in vacuum processes. With regard to possible embodiments of organic solar cells, reference may be made, in principle, to relevant literature, since known and, to a certain extent, commercially available organic solar cells may also be used, in principle, within the scope of the present invention.

The detector may furthermore include at least one electronic circuit, for example to amplify and/or at least partially process and/or output the at least one electrical signal. The detector may include, for example, at least one amplifier for amplifying the electrical signal. This amplifier and/or other electrical components of the detector may, in turn, be made entirely or partially with the use of organic materials. For example, the amplifier may include, in particular, at least one organic electronic element, preferably at least one organic transistor. In this manner, the preferably largely fully organic structure described above may be promoted, for example by constructing the scintillator at least partially as an organic scintillator, by using the organic photovoltaic element and by an electronic system being at least partially designed as an organic electronic system. At least one organic display element may furthermore be provided, as discussed in greater detail below. As illustrated above, the aforementioned, largely fully organic structure on the whole facilitates the manufacture of the detector, since similar production techniques may be used for the individual elements of the detector. Organic electronic components, in particular organic transistors, are generally elements which use one or multiple organic materials for carrying current, for example one or multiple organic conductor materials and/or semiconductor materials. Organic electronic elements of this type are also known, in principle, from the prior art.

The detector may be configured, in particular, to generate an item of dose information about a radiation dose of the ionizing radiation from the electrical signal. For example, the detector may directly or indirectly convert the at least one electrical signal completely or partially to the aforementioned dose information. This may take place, for example, using a corresponding evaluation electronic system and/or a data processing device which may be entirely or partially part of the detector and which may also, however, be situated entirely or partially outside the detector. For example, the electrical signal may be converted directly or indirectly into the dose information, for example with the aid of one or multiple corresponding items of calibration information. These items of calibration information may be stored, for example, in a data memory, which may also be entirely or partially included in the detector.

A particular advantage of organic photovoltaic elements, in particular organic solar cells and/or organic photodiodes, lies in the fact that they may, in principle, be designed to be flexible. Thus, the organic photovoltaic element may be designed, in particular, to be at least partially flexible, in particular as a film, preferably as a plastic film. The organic photovoltaic element may have, for example, a flexible carrier, for example a plastic carrier. As an alternative or in addition, other flexible carrier materials may also be used, for example, thin glass. Multi-layer substrate structures may also be used, for example plastic-glass laminates. Flexible carriers of this type are, in principle, known to those skilled in the art from the field of organic electronics and/or organic photovoltaics.

In a particularly preferred embodiment of the detector, this detector furthermore includes at east one display element that is configured to convert the electrical signal at least partially to at least one output signal that is perceptible to a user, in particular an optical output signal, in particular a visible optical output signal. For example, the display element may include one or multiple displays and/or illuminated panels and/or other types of optical display elements. As an alternative or in addition to optical display elements, however, display elements may be used which are able to generate output signals that are perceptible to a user, for example acoustic output signals and/or haptic output signals. For example, a warning tone or another type of acoustic warning signal may be output, a voice output or a vibration of the detector that is perceptible to a user may take place as an alternative or in addition to an optical display

It is particularly preferable if the organic photovoltaic element includes at least one array of organic photovoltaic elements, it also being possible for the display element to include an array of display elements. In this case, one or multiple fields in the array of photovoltaic elements may be assigned to fields in the array of display elements. This may be, for example, a 1:1 assignment, so that each field in the array of organic photovoltaic elements is assigned to precisely one field in the array of display elements. However, multiple fields in the array of organic photovoltaic elements and/or multiple fields in the array of display elements may also be combined, in principle, and/or individual or multiple fields may remain without an assignment. In this manner, for example, the at least one electrical signal of one field or multiple combined fields in the array of organic photovoltaic elements may be transferred to one field or multiple combined fields in the array of display elements, so that the optical output signals in the array of display elements may be assigned to the electrical signals in the array of organic photovoltaic elements, which may also be perceptible, for example, to a viewer. In this manner, a local resolution may be visualized, for example, for a viewer. For example an item of location information and/or an item of image information about the spatial distribution of the ionizing radiation may be generated in this manner and output to a user of the detector. The location information and/or the image information may also be used for corresponding imaging methods, for example in imaging radiodiagnostics and x-ray diagnostics.

In continuing the idea described above of the largely totally organic structure of the detector, with the possible exception of just a few elements, the detector may preferably be designed in such a way that the display element includes at least one organic light-emitting element, in particular at least one organic light-emitting diode. This organic light-emitting element may also be situated, in principle, in an array form, for example in the form of one or multiple organic light-emitting diode arrays. In particular, the organic light-emitting element may include at least one matrix display, for example in the form of a passive matrix display and/or an active matrix display. In principle, the organic light-emitting element may also be designed to be at least partially flexible, for example again using one or multiple flexible carrier materials, whereby reference may be largely made to the above description. The detector may thus be designed on the whole to be at least partially flexible, the term “flexible” within the scope of the present invention including, in principle, any type of deformability in at least one dimension, preferably a film-like deformability. In particular, the detector may have a total thickness of less than 3 mm, preferably 1 mm or less or particularly preferably even 500 micrometers or less.

Within the scope of the present invention, an organic light-emitting element is generally understood to be a light-emitting element, i.e., an element that emits light at least in the visible spectral range and which has at least one organic material, in particular an organic emitter material. In particular, the material may once again be a low-molecular and/or polymeric organic material, it being again possible, in turn, to use a layer structure of organic materials, including in possible combination with inorganic materials. The use of organic materials that have an extended π electron system, for example conjugated organic materials, are again preferred. The organic materials may include, for example, emitter materials and/or hole transporting materials and/or electron transporting materials as well as possible other materials such as buffer layers and the like. In principle, organic light-emitting diodes (OLEDs) may be understood to be, in particular, thin-film, light-emitting components that have at least one organic material, in particular an organic semiconducting material. The components have, for example, an asymmetrical characteristic, in particular, a diode characteristic. Reference may again be made to the prior art for the structure and functionality of organic light-emitting diodes, since known structural principles and manufacturing methods for producing organic light-emitting diodes and other types of organic light-emitting elements may be used, in principle, within the scope of the present invention. In particular, wet chemical manufacturing methods and/or vacuum manufacturing methods may again be used.

In principle, the aforementioned elements may be included in any arrangement within the detector. The only requirement is that the electromagnetic radiation generated by the scintillator must be detectable by the organic photovoltaic element. If a display element is included, this display element should be directly or indirectly connected, in particular, to the organic photovoltaic element, for example via an electronic circuit. In principle, the aforementioned elements may be situated, as a whole or in part, next to each other or above one another.

However, it is particularly preferable if the detector has a layer structure, the scintillator and the organic photovoltaic element being situated above each other in layers. If a display element is also provided, it may be integrated into the layer structure. For example, at least one scintillator layer, at least one layer of at least one photovoltaic element and at least one layer of at least one display element may be provided. In principle the layers may be provided in any order. However, if a display element is provided, the at least one layer of the display element should, in principle, be situated in such a way that it is visible to a user of the detector, for example as the top layer of the layer structure. The layer of the organic photovoltaic element is preferably situated adjacent to the layer of the scintillator, so that the electromagnetic radiation of the scintillator may be absorbed by the photovoltaic element. In principle, multiple elements may also be situated planarly in a layer in such a way that, for example, the display element and the organic photovoltaic element may be at least partially situated planarly in a layer. For example, an array of the organic photovoltaic element, for example an organic solar cell array and/or an organic photodiode array, may be combined with a display element array in a layer. For example, one or multiple fields in the array of the photovoltaic element may each be situated adjacent to one or multiple fields in the array of the display element. In particular, an array of an organic photovoltaic element may be combined in this manner with an array of an organic light-emitting element, for example an organic solar cell array may be combined with an organic light-emitting diode array.

The detector in one or more of the specific embodiments described above has numerous advantages over known detectors for the qualitative and/or quantitative detection of ionizing radiation. Thus, the basic structure may be an organic solar cell which is designed in array form, combined as a block, for example, with an organic scintillator lying above it. The scintillator converts ionizing radiation to visible light, which may be detected, in particular measured, for example using the organic solar cells. An organic transistor may optionally amplify the obtained electrical signal. The at least one amplifier may furthermore include an analog/digital converter, and/or it may be connected or connectable to an analog/digital converter of this type. Analog electrical signals may be, for example, further processed and/or digitized in an analog/digital converter of this type. A dose measurement all the way to the percentage range may be achieved with the aid of a calibration.

Since the detector generally provides the opportunity to use very thin materials, in particular thin organic layers, the general absorption of the ionizing radiation by the detector itself may be kept low. This may be utilized, for example, by the fact that the detector is used directly at a beam outlet of an irradiation system, without changing the primary beam. This makes it possible to achieve a precise measurement of the fluence of the ionizing radiation, for example at a resolution of less than 1 mm.

The use of flexible materials, such as flexible plastic materials, for example for the organic photovoltaic element and/or the organic light-emitting element, also offers numerous design advantages. The detector as a whole may thus be designed to be flexible, for example flexible in the manner of a conventional film, and it may thus be used, for example, as a film replacement. The advantages of a film may thus be combined with those of a digital detector. Conventional digital detectors are usually designed to be rigid and thick yet in may cases directly readable, and they have a low to high resolution. Conventional films, on the other hand, are flexible and thin yet usually readable only after being developed and/or after being scanned; however, they have a high resolution. The use of a flexible detector according to the present invention makes it possible to combine the advantages of digital detectors and conventional films, so that a thin, flexible and yet directly readable detector of high resolution may now be provided, for example using the display element described above. A suitable combination of the features described above thus makes it possible, for example, to completely replace a film material with the detector illustrated herein, for example in the form of an electronic film, so that, for example, common processes may be completely or at least partially digitized.

A further advantage of the proposed detector is the optional combination of organic photovoltaic elements, for example organic solar cells, with organic light-emitting elements, for example OLEDs. For example, the organic light emitting element may be used in a top layer of a layer structure, as described above, for example in the form of a matrix display. The organic photovoltaic element may be used, for example, as the bottom layer of the layer structure. However, other layer structures are possible, in principle, as illustrated above. The organic photovoltaic element may be used to provide energy to the display element, for example the OLED. The energy may be transferred to the OLED, which subsequently lights up, thus guaranteed direct readability.

In addition to the proposed detectors in one or more of the described specific embodiments, the fact that the detector may be designed, in principle, in any form is furthermore utilized. For example surfaces that may come into contact with radioactive materials may be coated with the detector in one or more of the described forms. If such materials are located on the surface, the detector may generate at least one electrical signal which may be output directly or indirectly to a user, for example via the at least one display element. For example, a current may be generated in the organic solar cells which may be either amplified or used directly as energy for operating organic light-emitting diodes.

Accordingly, a coating is proposed for application to surfaces which are potentially contaminated with contaminants generating ionizing radiation, these surfaces having at least one or multiple detectors in one or more of the embodiment variants described above. The advantage of a coating of this type with regard to radiation hygiene may be that surfaces that are contaminated, for example, light up immediately. For example, this illumination may be discontinued only after the contaminants have been removed. This makes it possible to visually inspect contaminants that generate otherwise invisible ionizing radiation. This substantially increases safety in working with corresponding beams.

As an alternative or in addition to a coating, however, the detector may, in principle, be generally integrated into objects in any other way, since the detector may be designed to be very versatile, in particular flexible, with regard to it shape and material properties. For example, a detector may be integrated into fabric in one or more of the described forms, for example into a radiation protection suit. The detector may furthermore be integrated, for example, into a lead apron. The detector may furthermore also be integrated, for example, into a medical drape which is used, for example, in medical procedures. This makes it possible to directly visualize exposure to ionizing radiation. As an alternative or in addition, a cleaning device may furthermore be implemented which, for example, may be designed as a cleaning cloth, for example a wipe. Another design in the form of a cloth or, for example in the form of a sponge, is also possible, in principle. The cleaning device may be used to clean surfaces which are potentially contaminated by contaminants that generate ionizing radiation. The cleaning device may be designed to be at least partially flexible and to include at least one detector in one or more of the specific embodiments described above. Cloths, for example, with the aid of which an unintentional radiation exposure and/or contamination with radioactive materials may be quickly and reliable detected, may be produced in this manner. For example, the cleaning device, in particular the cleaning cloth, may light up if corresponding contamination is detected.

An irradiation system is furthermore proposed, as described above. This irradiation system includes at least one radiation source for generating ionizing radiation. This radiation source may be, for example, a radioactive radiation source, for example a radiation source for generating α and/or β and/or γ and/or neutron radiation and/or x-rays. As an alternative or in addition, an x-ray source may also be used. The irradiation system furthermore includes at least one detector in one or more of the embodiment variants described above, which is situated in the beam path of the irradiation system. The irradiation system may be used, in particular, to precisely monitor and/or control or regulate an emission of the ionizing radiation. A spatial distribution of the emission of the ionizing radiation and/or an online monitoring of a radiation dose, a radiation intensity, a radiation distribution or similar variables may also be implemented in this manner.

A method for monitoring an irradiation system is furthermore proposed which has at least one radiation source for generating ionizing radiation. For example, the irradiation system may be an irradiation system according to the above description. At least one detector in one or more of the embodiment variants described above is used and situated in a beam path of the irradiation system. In particular, the detector may be situated in a beam outlet of the ionizing radiation. This may be used, for example, to measure a fluence at the beam outlet and/or for online verification of irradiation.

A method for detecting contaminants that generate ionizing radiation, in particular radioactive contaminants, is furthermore proposed. At least one detector in one or more of the specific embodiments described above is used for the method. The detector is brought close to an object that is potentially contaminated with the contaminants. The detector may be brought close to the object up to a distance from the object and/or until the detector touches the object. For example the touching may take place in the form of a wiping action. The detector may also be placed onto an objet and/or used to rub the object. At least one output signal of the detector is monitored, and a presence or absence of contaminants is inferred from the output signal.

Beyond the advantages already described above, the proposed devices and methods offer the opportunity to provide thin, flexible detectors as a film replacement in a wide range of applications. In particular, active surfaces may be implemented to detect radiation exposure. This also makes it possible to open up applications that, for practical reasons, have up to now been mainly accessible to radiation hygiene and/or radiation protection. In general, the areas of radiation protection and/or radiation hygiene may be expanded and made more economical and safer. The use of flexible organic structures instead of difficult-to-implement semiconductor detectors or ionizing chambers also offer considerable cost advantages. In addition, radiation exposure may be displayed directly, for example in the form of a display of radioactive radiation on surfaces. Radioactive contaminants on surfaces may be directly visualized in this manner.

### BRIEF DESCRIPTION OF THE FIGURES

Further details and features of the inventions are derived from the following description of preferred exemplary embodiments, in particular in connection with the subordinate claims. The respective features may be achieved either alone or in multiple combinations with each other. The invention is not limited to the exemplary embodiments. The exemplary embodiments are illustrated schematically in the figures. The same reference numerals in the figures identify the same or functionally equivalent elements or elements that correspond to each other in terms of their functions.

Specifically,

FIG. 1 shows a simple layer structure of a first exemplary embodiment of a detector;

FIG. 2 shows a schematic representation of a possible organic photovoltaic element in the form of an array;

FIG. 3 shows an exemplary embodiment of a detector which has a layer structure including an array of an organic photovoltaic element and an array of an organic light-emitting element;

FIG. 4 shows an exemplary embodiment of an irradiation system;

FIG. 5 shows an exemplary embodiment of an object coated with a coating according to the invention;

FIG. 6 shows an exemplary embodiment of a cleaning device; and

FIG. 7 shows an exemplary embodiment of a detector which has a layer structure including an insulation layer between the display element and scintillator.

### DETAILED DESCRIPTION OF THE INVENTION

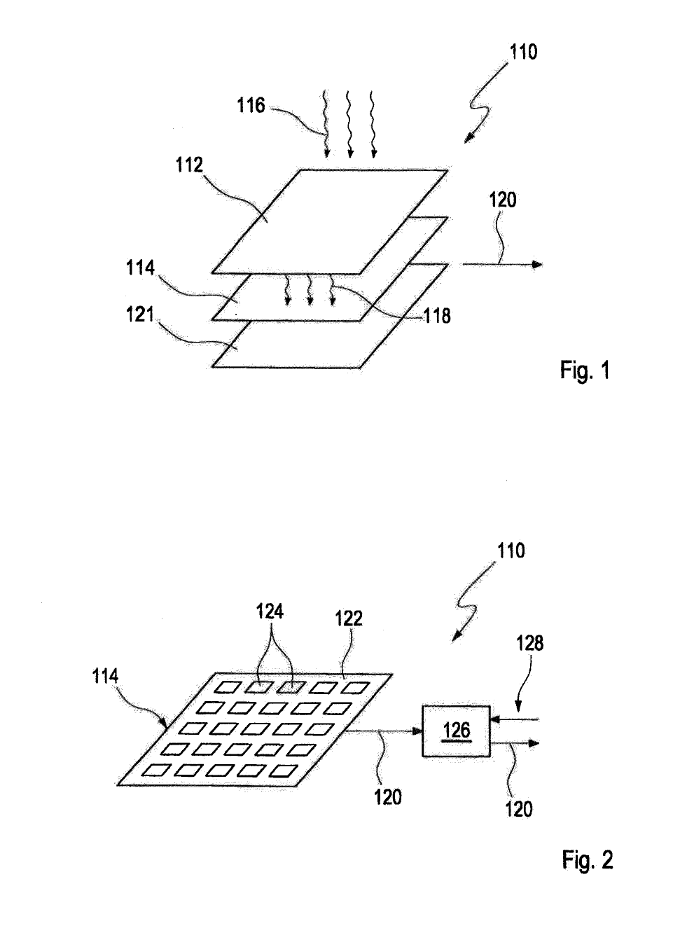

FIG. 1 shows a highly schematic representation of a simple exemplary embodiment of a detector 110 according to the invention for detecting ionizing radiation. In this exemplary embodiment, detector 110 is implemented as a layer structure and includes one layer of a scintillator 112, for example an organic scintillator 112, and one layer of an organic photovoltaic element 114, for example a layer of an organic solar cell. Scintillator 112 is configured to at least partially absorb ionizing radiation 116 and to convert it to electromagnetic radiation 118. Organic photovoltaic element 114, in turn, is configured to at least partially absorb organic electromagnetic radiation 118 and to generate at least one electrical signal, which is identified symbolically by reference numeral 120 in FIG. 1. For example a carrier layer, which is identified symbolically by reference numeral 121 in FIG. 1, may furthermore be optionally provided in this exemplary embodiment of detector 110.

FIG. 2 shows a possible embodiment of organic photovoltaic element 114. This element may have, for example, a flexible carrier 122 on which an array 124 of individual photovoltaic elements 114 is mounted. For example, the array may be an organic solar cell array. For example, this array may be segmented into suitable segments, depending on the application. For example, an array form having squares to be filled or another filling strategy of hexagons may be suitable. In principle, the coverage should be as complete as possible to avoid losing measured data.

The at least one photovoltaic element 114 and/or array 124 of photovoltaic elements 114 may be based, for example, on the use of photodiodes and/or photoelements. A photodiode may be used, in particular, in that a resistance of the photodiode changes in the presence of incident light radiation. This may be utilized and/or measured, for example, by measuring a current flowing through the photodiode. A typical circuit structure may be provided, for example, so that a voltage is applied to the photodiode and a current is first converted by a current/voltage converter, and the voltage is then amplified and digitized. As an alternative or in addition, a photoelement may be used, for example an organic solar cell. Charges may be generated which may then be temporarily stored, for example in a capacitor, in a manner similar to an electrical circuit of a CCD element (CCD: charge-coupled device).

Each individual photovoltaic element 114 may have a layer structure. For example, a layer structure of this type may provide a combination of at least one layer of an electron donator and at least one layer of an electron acceptor and/or mixed layers having both properties. For example, a layer structure having at least one layer of poly(3-hexylthiophene) (P3HT) as the electron donator and at least one layer of [6,6]-phenyl-C61-butyric acid methyl ester (PCBM) as the electron acceptor may be used, for example in the form of an organic 2-layer structure. This organic layer structure may be embedded between at least two electrodes, of which at least one electrode, for example, is mounted on a carrier, for example a transparent carrier. A voltage may be applied between the two electrodes (anode, cathode). If an electron/hole pair is generated, it is drawn to the corresponding electrode and generates a current. A structure without an external voltage is also conceivable. For example, a typical layer structure may provide the following layer sequence: an electrode, for example an optically transparent Ca/Ag double layer just a few nanometers thick, followed by an active organic layer or layer sequence, followed by an optional intermediate layer for minimizing a dark current, for example polystyrene sulphonate, for example having a thickness of one micrometer, followed by a second electrode, followed, in turn, by a carrier material. The system should furthermore be encapsulated to avoid oxidative problems.

Scintillator 112 of detector 110 is not illustrated in FIG. 2. In principle, a classic layer structure having a scintillator 112 on top and an underlying photovoltaic element 114, for example in the form of at least one photodiode and/or at least one solar cell, is preferred. For example, scintillator 112 may be mounted over organic photovoltaic element 114 in the form of a block, for example as shown in FIG. 1. Scintillator 112 may generate electromagnetic radiation 118 from ionizing radiation 116, for example visible light, which may be converted to a current and/or a voltage in photovoltaic element 114. In the exemplary embodiments in FIGS. 1 and 2, scintillator 112 may include, for example, anthracene, stilbene, terpenyl, dophenylazenthylene, polyvinyl toluene, toluene or xylene or combinations of the aforementioned and/or other scintillator materials. Other scintillator materials that may also be used within the scope of the present invention, are described, for example, in Hanno Krieger: Grundlagen der Strahlungsphysik and des Strahlenschutzes (Fundamentals of Radiation Physics and Radiation Protection), Volume 2, pp. 177-178, Table 2.3.

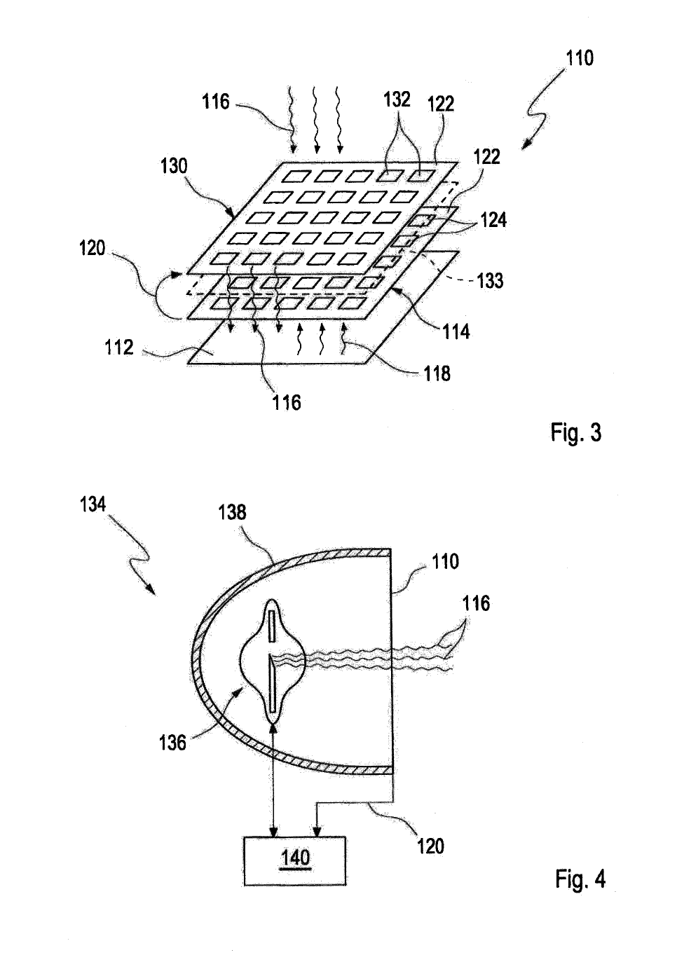

In the exemplary embodiment illustrated in FIG. 2, as well as in the other exemplary embodiments according to FIGS. 1 and 3, detector 110 may furthermore include one or multiple additional layers, which are not illustrated in the figures, for example one or multiple carrier layers 121 or layers of a carrier material which may be used, for example as the bottom layer of the layer structure in FIGS. 2 and 3 and/or as intermediate layers. The at least one optional layer of carrier material may furthermore be combined with one or multiple other elements of detector 110, for example with scintillator 112 and/or photovoltaic element 114 and/or an array 124 of photovoltaic elements 114 and/or display element 130, which is illustrated in greater detail below, or an array 132 of display elements 132. As an alternative or in addition, the at least one optional layer of carrier material may, however, also be designed as an independent layer, for example as the bottom layer of an overall layer structure, as explained above.

In this exemplary embodiment or in other exemplary embodiments, detector 110 may include an activation and/or evaluation electronic system 126. This is indicated symbolically in FIG. 2. For example, this activation and/or evaluation electronic system 126 may be implemented entirely or partially as organic electronic system. Activation and/or evaluation electronic system 126 may include, for example, one or multiple amplifiers and/or one or multiple analog/digital converters and/or one or multiple evaluation elements, for example in order to process or preprocess electrical signal 120 either entirely or partially within the detector. An output of dose information may also take place in this manner. No distinction is made in FIG. 2 between electrical signal 120 upstream and downstream from activation and/or evaluation electronic system 126, it naturally being possible, however, for differences to exist between electrical signals 120. Activation and/or evaluation electronic system 126 may also be implemented entirely or partially as organic electronic system, for example using one or multiple organic transistors. Hybrid structures are also possible, in principle. Electrical signals 120 generated and/or modified by activation and/or evaluation electronic system 126 may be output to a user and/or other devices, for example via an interface 128. As an alternative or in addition, electrical signals 120 may, however, also be forwarded directly or indirectly to other components of detector 110 via interface 128 or circumventing this interface 128. For example, as explained in greater detail on the basis of FIG. 3, electrical signals 120 may be transferred to one or multiple display elements 130.

FIG. 3 shows an exemplary embodiment of a detector 110 according to the invention which has at least one display element 130. Detector 110 is again implemented by way of example as a layer structure having a scintillator 112 and an array 124 of photovoltaic elements in a manner similar, for example, to FIG. 2. Display element 130, which may be implemented, for example, as an organic light-emitting element, in particular as an OLED, is also implemented as array 132 in this case. For example, one or multiple fields of array 132 may be assigned to one or multiple fields of array 124.

Ionizing radiation 116 may penetrate, for example, one or multiple layers of the layer structure and reach scintillator 112. Although scintillator 112 is implemented herein as a scintillator covering a wide area, it may also be designed, as an alternative or in addition, entirely or partially in the form of an array of individual or multiple scintillators. As an alternative or in addition, a geometry which is adapted to the application at hand and/or a segmentation of scintillator 112 may be used. As illustrated in FIG. 3, ionizing radiation 116 is, in turn, converted in scintillator 112 to electromagnetic radiation 118, which, in turn, may be converted to electrical signals 120 in organic photovoltaic element 112. As indicated in FIG. 3, these electrical signals 120 may be output directly or indirectly to display element 130. A complete or partial intermediate processing may also take place, for example an amplification of the signals, for example in a manner similar to FIG. 2. In this manner, for example, an illumination of display element 130, for example, an all-over and/or a local illumination, may indicate ionizing radiation 116 and/or substances generating ionizing radiation 116. Detector 110 according to FIG. 3 may be designed, for example, as a film, so that the detector may replace, for example, conventional radiation detection films and be used, for example, for the all-over or local detection of ionizing rays 116. Ionizing radiation 116 may be directly visualized for a user by the fact that display element 130 lights up. This combines the advantages of common digital detectors with the advantages of conventional films.

It should be generally noted that the layer structure illustrated in FIG. 3 is not absolutely necessary. The layer structure may thus include a different layer sequence. For example, scintillator 112 may be situated between organic photovoltaic element 114 and display element 130. Moreover, each of the elements illustrated may, in turn, have its own layer structure. For example, common organic photovoltaic elements 114 and/or common display elements 130 may, in turn, be implemented as the layer structure. For example, these elements may each include one or multiple sandwich structures, for example having a carrier, two or more electrodes and at least one organic material embedded therebetween. Reference may be made to the prior art in this regard.

At least one insulation layer, which is shown as an option by the dotted line in FIG. 3 and is identified by reference numeral 133, may furthermore be integrated into the layer structure according to FIG. 3 as well as into other layer structures, for example according to FIGS. 1 and 2. This insulation layer 133 may be designed to be, for example, non-transparent to visible light or have low transparency, and it may prevent, for example, visible light from reaching photovoltaic element 114 or at least to be weakened before it reaches photovoltaic element 114.

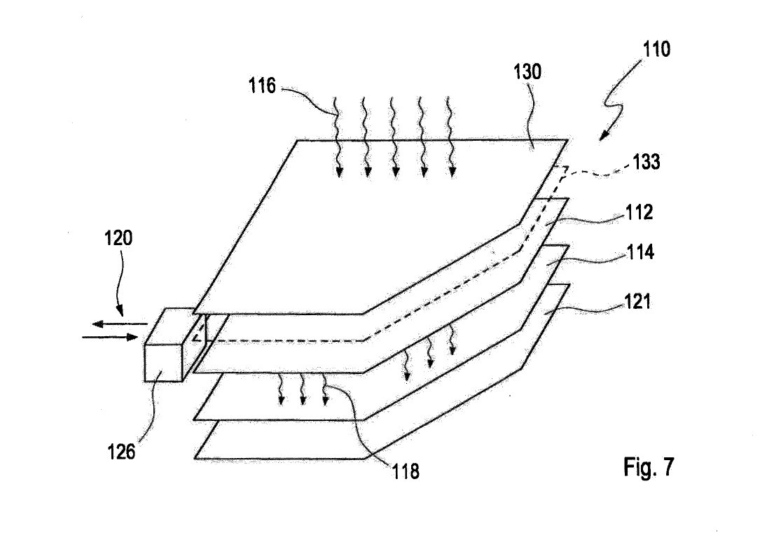

FIG. 7 shows another exemplary embodiment of a detector 110, in which an insulation layer 133 may be used. In this exemplary embodiment, a carrier layer 121 is again optionally provided as the bottom layer. A layer of an organic photovoltaic element 114 is provided thereover, for example an organic photovoltaic element covering a wide area. A layer of scintillator 112 is provided thereupon. With the aid of this layer structure, an insulation layer 133 is provided which is preferably at least partially transparent to ionizing radiation 116 striking from above, so that this ionizing radiation may reach organic photovoltaic element 114. On the other hand, this insulation layer 133 is, however, at least partially non-transparent to visible light, so that no or only slight corruption of the signal of organic photovoltaic element 114 may be caused by the visible light. A display element 130 is again situated over insulation layer 133, preferably in the form of a light source covering a wide area, preferably an organic light-emitting diode. This light source may be activated by two or more electrodes.

Organic photovoltaic element 114 in the layer structure shown in FIG. 7 may, in turn, be designed in different ways. For example, it may be designed as a photodiode and/or as a solar cell and/or as another organic photovoltaic element which generates an electrical signal in response to electromagnetic radiation 118 generated by scintillator 112. This signal may cause display element 130, for example the OLEDs, to be activated, for example, in electronic circuits positioned in distributed locations. The at least one display element 130 may light up or emit other optical signals, for example flashing signals and/or symbols, for example a symbol for radioactivity.

FIG. 4 shows a schematic representation of an exemplary embodiment of an irradiation system 134 according to the invention for generating ionizing radiation 116. Irradiation system 134 includes a radiation source 136, which in this case is accommodated, for example, in a housing 138 and which generates ionizing radiation 116. Radiation source 136 is symbolized herein by way of example as x-ray tubes. As an alternative or in addition, however, other radiation sources 136 may be used, for example α and/or β and/or γ and/or neutron radiation sources and/or x-ray sources.

Irradiation system 134 may furthermore include a control unit 140, which is indicated symbolically in FIG. 4. A detector, for example according to one or more of the specific embodiments described above, is situated in the beam path of irradiation system 134. Since detector 110 may be designed, for example, to be very thin, and because it may be manufactured, for example, using materials that absorb only slightly ionizing radiation 116, this arrangement of detector 110 does not or only insignificantly influence the intensity and/or spatial distribution of ionizing radiation 116. An electrical signal 120 generated by detector 110 may be output, for example, to control unit 140 and/or to another device which is not illustrated. For example, irradiation system 134 may be activated in this manner with regard to an intensity and/or spatial distribution of ionizing radiation 116. As an alternative or in addition, however, ionizing radiation 116 may also be directly visualized for the user with the aid of detector 110.

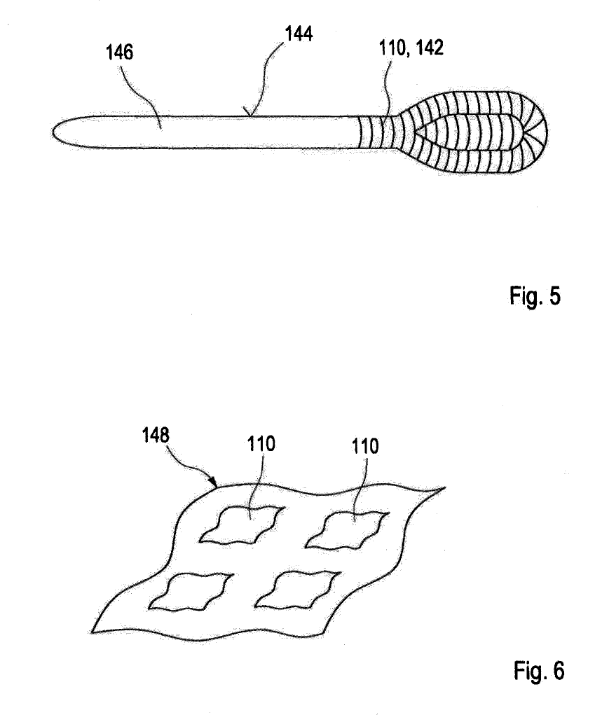

FIG. 5 shows an exemplary embodiment which illustrates the fact that detector 110 may also be implemented entirely or partially in the form of a coating 142 and/or be implemented in another manner in ordinary objects. For example, coating 142 includes a layer structure that has a scintillator 112, an organic photovoltaic element 114 and a display element 130, each of which, for example, covers a wide area. The coating may be applied, for example, to a surface 144 of, in principle, any object 146 that may be potentially contaminated by contaminants which generate ionizing radiation. In the illustrated exemplary embodiment, object 146 is symbolized as a spatula. However, other objects 146 may also be used, for example objects from the area of laboratory diagnostics, for handling radioactive substances, in the area of radiation diagnostics or radiation therapeutics. A contamination may be visualized in this manner, for example by the fact that surface 144 lights up.

Finally, an exemplary embodiment of a cleaning device 148 is illustrated in FIG. 6. This cleaning device 148 is implemented in this example as a cloth that may be used, for example, to wipe potentially contaminated surfaces. One or multiple detectors 110 are integrated into this cleaning device 148, it also being possible to design cleaning device 148 entirely as detector 110. In particular, the option of a flexible embodiment of detectors 110 may again be utilized in this case. In principle, detectors 110 may again be designed according to the above description. By using cleaning device 148 to wipe potentially contaminated surfaces, contamination by contaminants that generate ionizing radiation may again, for example be visualized directly for a user, for example by the fact that cleaning device 140 lights up over a wide area or locally.

### LIST OF REFERENCE NUMERALS

110 Detector for detecting ionizing radiation
112 Scintillator
114 Organic photovoltaic element
116 Ionizing radiation
118 Electromagnetic radiation
120 Electrical signal
121 Carrier layer
122 Flexible carrier
124 Array of photovoltaic elements
126 Activation and/or evaluation electronic system
128 Interface
130 Display element
132 Array of display elements
133 Insulation layer
134 Irradiation system
136 Radiation source
138 Housing
140 Control unit
142 Coating
144 Surface
146 Object
148 Cleaning device

1. A detector for detecting ionizing radiation, comprising at least one scintillator, the scintillator being configured to convert the ionizing radiation to electromagnetic radiation, in particular to visible, ultraviolet or infrared light, the detector furthermore comprising at least one organic photovoltaic element, the organic photovoltaic element being configured to convert the electromagnetic radiation to at least one electrical signal.

2. The detector according to claim 1, wherein the scintillator includes at least one organic scintillator material.

3. The detector according to claim 1, wherein the organic photovoltaic element includes at least one organic solar cell and/or at least one organic photodiode, in particular at least one organic solar cell array and/or at least one organic photodiode array.

4. The detector according to claim 1, furthermore comprising at least one amplifier for amplifying the electrical signal, in particular an amplifier which includes at least one organic electronic element and preferably an organic transistor.

5. The detector according to claim 1, wherein the detector is configured to generate an item of dose information about a radiation dose of the ionizing radiation from the electrical signal.

6. The detector according to claim 1, wherein the organic photovoltaic element is designed to be at least partially flexible, in particular as a film, preferably as a plastic film.

7. The detector according to claim 1, furthermore comprising at least one display element, the display element being configured to convert the electrical signal to at least one output signal that is perceptible to a user, in particular an optical output signal.

8. The detector according to claim 1, wherein the organic photovoltaic element includes at least one array of organic photovoltaic elements, the display element including an array of display elements, fields in the array of organic photovoltaic elements being assigned to fields in the array of display elements.

9. The detector according to claim 1, wherein the display element includes at least one organic light-emitting element, in particular at least one organic light-emitting diode, in particular an organic light-emitting diode array.

10. The detector according to claim 1, wherein the detector has a layer structure, the scintillator and the organic photovoltaic element and preferably the display element being situated above each other in layers.

11. A coating for application to surfaces that are potentially contaminated by contaminants generating ionizing radiation, the coating having at least one detector according to claim 1, relating to a detector.

12. A cleaning device, in particular a cleaning cloth, for cleaning surfaces that are potentially contaminated by contaminants generating ionizing radiation, the cleaning device being designed to be at least partially flexible and having at least one detector according to claim 1, relating to a detector.

13. An irradiation system, comprising at least one radiation source for generating ionizing radiation, furthermore comprising at least one detector according to claim 1, relating to a detector which is situated in a beam path of the irradiation system.

14. A method for detecting contaminants generating ionizing radiation, in particular radioactive contaminants, at least one detector according to claim 1, relating to a detector being brought close to an object that is potentially contaminated by the contaminants, the detector being mounted, in particular, on the object and/or used to rub the object, at least one output signal of the detector being monitored, and a presence or absence of the contaminants being inferred from the output signal.

15. A method for monitoring an irradiation system, the irradiation system having at least one radiation source for generating ionizing radiation, at least one detector according to claim 1, relating to a detector being situated in a beam path of the irradiation system, in particular at a beam outlet of the ionizing radiation.
